(19) United States
(12) Patent Application Publication
(10) Pub. No.: US 2011/0093176 A1
(43) Pub. Date: Apr. 21, 2011

(54) METHOD FOR ACTUATING A HYDRAULIC OPERATED CLUTCH AND CONTROLLER

(75) Inventor: Christian KUNZE, Gross-Gerau (DE)

(73) Assignee: GM GLOBAL TECHNOLOGY OPERATIONS, INC., Detroit, MI (US)

(21) Appl. No.: 12/860,270

(22) Filed: Aug. 20, 2010

(30) Foreign Application Priority Data
Aug. 20, 2009 (GB) 0914566.5

(51) Int. Cl. F16D 43/284; F16D 43/286

(52) U.S. Cl. 701/68

(57) ABSTRACT

A method is provided for actuating a hydraulic operated clutch of an automotive gear box for shifting gears, that includes, but is not limited to the steps of collecting data from a CAN-bus system, which includes, but is not limited to data about torque and speed of the gear box particularly of an input shaft and/or of an output shaft, and adjusting the engagement time for engaging the input shaft with the output shaft based on the collected data by adjusting the maximum hydraulic diameter for a working fluid for operating the clutch. By using the information provided by the CAN-bus the exact situation of the transmission system during the shifting of the gears can be estimated. Based on the information provided by the CAN-bus it is possible to allow at mainly every situation a maximum fast coupling without significant impairments with respect to the provided comfort.

### CROSS-REFERENCE TO RELATED APPLICATION

This application claims priority to British Patent Application No. 0914566.5, filed Aug. 20, 2009, which is incorporated herein by reference in its entirety.

### TECHNICAL FIELD

The technical field relates to a method for actuating a hydraulic operated clutch of an automotive gear box for shifting gears as well as a controller for carrying out such kind of a method.

### BACKGROUND

Hydraulic operated clutches for shifting gears of an automotive gear box transmit torque from an input shaft to an output shaft by means of friction. In the engaged state a first clutch element, which is connected to the input shaft, is pressed against a second clutch element, which is connected to the output shaft, for transferring torque. For shifting a gear first the clutch is actuated for disengaging the input shaft from the output shaft. Then the gear is shifted and after the shift the clutch is released for bringing the input shaft into engagement to the output shaft. In passenger vehicles with common manual transmissions the output of the clutch is pressed against the input by a spring. A force is necessary to disengage the clutch input from the clutch output, i.e. the force is acting on the spring and compresses the spring so that an axial movement is realized. This disengagement force is realized by using hydraulic pressure. To engage the clutch the hydraulic pressure is reduced so that the spring force is exceeding the hydraulic pressure force. This leads to an axial movement and to an engaging of the clutch. When the clutch elements come into contact the possible relative speed differences between input side and output side are leveled by friction between both sides. The axial force during the engagement leads to friction on the surfaces of the clutch in case of different speeds. This friction leads to a synchronization of the speeds.

It is a disadvantage of such kind of a clutch operating method that particularly in manual transmission systems a driver may release the clutch actuation system too fast, so that the clutch elements make suddenly hard contact with each other resulting in undesired high peaks in the transmitted torque Depending on the magnitude of this peak the driver can either experience an uncomfortable clutching behavior or the torque peaks can even damage components that are attached to the clutch system. When exceeding the normal load the transmission and the clutch is designed to withstand theses peak torques are considered as “abusive loads.” These abusive loads can occur during snap starts and overrun snaps. A snap start is considered as launch of the vehicle with high speed difference between clutch input and clutch output when suddenly engaging the clutch. The synchronization of the high speed difference between input and output leads to dynamic forces in the entire driveline. These dynamic forces or abusive loads contribute damage to mechanically loaded components in the power flow such as gearwheels, shafts and transmission housings.

It is at least one object of the invention to provide a method for actuating a hydraulic operated clutch as well as a controller, by means of which the risk for abusive loads when operating a clutch is reduced. In addition, other objects, desirable features, and characteristics will become apparent from the subsequent summary and detailed description, and the appended claims, taken in conjunction with the accompanying drawings and this background.

The method according to an embodiment of the invention for actuating a hydraulic operated clutch of an automotive gear box for shifting gears comprises the step of collecting data from a CAN-bus system, which comprises data about torque and speed of the gear box particularly of an input shaft and/or of an output shaft. It is adjusted the engagement time for engaging the input shaft with the output shaft based on the collected data by adjusting the maximum hydraulic diameter for a working fluid for operating the clutch.

By using the information provided by the vehicle CAN-bus system the exact situation of the transmission system during the shifting of the gears can be estimated. Based on the information provided by the CAN-bus it can be calculated how fast and how hard an engagement contact of the clutch may be without an uncomfortable feeling for the driver of the vehicle. Abusive loads when operating the clutch may be prevented. The adjustment how fast and how hard an engagement contact of the clutch should occur can be realized by limiting the hydraulic diameter for the working fluid. Due to the limited hydraulic diameter a maximum engagement speed and applied volumetric flow of the working fluid can be limited even in the case, when the driver accidentally would apply a too high torque peak. The limitation of the hydraulic diameter of the working fluid can be realized by simple constructive designs like an orifice whose hydraulic diameter can be adjusted by moving a cover or the like. However, it is not necessary to restrict the hydraulic diameter to the same value all the time. Depending on the information provided by the CAN-bus a faster and harder engagement contact of the clutch can be acceptable at different transmission parameters. Thus, it is possible to allow at mainly every situation a maximum fast coupling without significant impairments with respect to the provided comfort.

Particularly the method comprises the step of detecting an intended actuation of the clutch for engaging an input shaft with an output shaft. A permanent adjustment of the hydraulic diameter can be prevented. Instead the adjustment of the hydraulic diameter can be initiated only when needed. For instance, when a disengagement of the clutch and/or the actuation of a drivers clutch pedal is detected, the adjustment of the hydraulic diameter starts, particularly until the engaged status is reached, when the revolution of the input shaft corresponds mainly to the revolution of the output shaft.

Preferably an actual maximum allowed engagement speed for the relative movement of the input shaft towards the output shaft is calculated and the maximum hydraulic diameter is adjusted for limiting the actual hydraulic pressure based on the actual maximum allowed engagement speed. By choosing the engagement speed as main control variable a hard contact of the clutch can be prevented. Further it is taken into account that the maximum allowed engagement speed can be different during the coupling process. For instance a higher engagement speed can be allowed at begin of the relative movement of the input shaft towards the output shaft, when both shafts are positioned significantly spaced to each other. At this time the maximum allowed engagement speed can be significantly higher than the maximum allowed engagement speed, when the input shaft is close to the output shaft and a soon contact is expected. Shortly prior to the contact and after the contact of the clutch elements of the input shaft and the output shaft a significantly lower engagement speed and/or hydraulic pressure is allowed since the revolutions of the input shaft not yet corresponds to the revolutions of the output shaft. However, the hydraulic pressure may increase, when the difference of the revolutions of the input shaft and the output shaft decrease.

Particularly an actual actuating speed of releasing the clutch, particularly a moving speed of a clutch pedal, is detected and used for adjusting the maximum hydraulic diameter. By detecting the actuating speed for instance of the clutch pedal it is possible to collect an information about the expected engagement speed at a very soon point of time. Particularly the course of the actuating speed provides information in advance about the situation of the hydraulic system of the clutch, so that a feed forward control of the hydraulic diameter is possible.

Preferably a speed difference between the input shaft and the output shaft and/or a shifted gear is used for adjusting the maximum hydraulic diameter. It is used the insight that at different transmission situations different engagement times are recommendable. based on the revolution differences of the shafts and/or the actual gear the reaction of the transmission system to a particular engagement pressure or the like can be estimated. This allows providing an engagement time as short as possible without impairing the comfort to the driver.

In a further embodiment a higher maximum hydraulic diameter is set before an engagement of the input shaft to the output shaft and/or a lower maximum hydraulic diameter is set after an engagement of the input shaft to the output shaft. A higher engagement speed can be allowed at begin of the relative movement of the input shaft towards the output shaft, when both shafts are positioned significantly spaced to each other. Shortly prior to the contact and after the contact of the clutch elements of the input shaft and the output shaft a significantly lower engagement speed and/or hydraulic pressure is allowed since the revolutions of the input shaft not yet corresponds to the revolutions of the output shaft. This allows providing an engagement time as short as possible without impairing the comfort to the driver.

The embodiments of the invention further relate to a controller for actuating a hydraulic operated clutch of an automotive gear box for shifting gears. The controller is particularly suitable for carrying out the method as previously described. The controller comprises a CAN-bus interface for collecting data from a CAN-bus system, which comprises data about torque and speed of the gear box particularly of an input shaft and/or of an output shaft. The controller further comprises an adjustment device for adjusting the maximum hydraulic diameter of an orifice of a hydraulic duct for a working fluid for operating the clutch and an operating unit for operating the adjustment device in dependency of the collected data for adjusting the engagement time for engaging the input shaft with the output shaft. The controller may be designed as previously described with respect to the method of operating a clutch. By using the information provided by the vehicle CAN-bus system the exact situation of the transmission system during the shifting of the gears can be estimated. Based on the information provided by the CAN-bus it is possible to allow at mainly every situation a maximum fast coupling without significant impairments with respect to the provided comfort.

Particularly the operating unit is connected to a clutch pedal detector for detecting an actual actuating speed of releasing the clutch. By detecting the actuating speed of the clutch pedal it is possible to collect an information about the expected engagement speed at a very soon point of time, so that a feed forward control of the hydraulic diameter is possible.

The embodiments of the invention further relates to a peak torque limiter for limiting a transferred torque. The peak torque limiter (“PTL”) comprises a hydraulic duct for a working fluid for operating a clutch of an automotive gear box for shifting gears and a controller for adjusting the maximum hydraulic diameter of the hydraulic duct. The controller can be designed as previously described. By using the information provided by the vehicle CAN-bus system the exact situation of the transmission system during the shifting of the gears can be estimated. Based on the information provided by the CAN-bus it is possible to allow at mainly every situation a maximum fast coupling without significant impairments with respect to the provided comfort.

Preferably the maximum hydraulic diameter is adjusted by means of a slider, which particularly is movable mainly perpendicular to a flow direction of the working fluid inside the hydraulic duct. The limitation of the hydraulic diameter of the working fluid can be realized by a simple constructive design, like a slide valve. The slider is particularly positioned at a place, where the duct is mainly straight. The slider is preferably arranged at a place where the duct already comprises a small hydraulic diameter, particularly the smallest hydraulic diameter.

The embodiments of the invention further relates to a transmission system for an automotive gear box for shifting gears. The transmission system comprises a peak torque limiter, which can be designed as previously described, wherein the hydraulic duct is connected via a hydraulic master cylinder to a clutch pedal and via a hydraulic slave cylinder to a clutch of the automotive gear box. Between the master cylinder and the slave cylinder the maximum hydraulic diameter of the duct can be adjusted. By using the information provided by the vehicle CAN-bus system the exact situation of the transmission system during the shifting of the gears can be estimated. Based on the information provided by the CAN-bus it is possible to allow at mainly every situation a maximum fast coupling without significant impairments with respect to the provided comfort.

### BRIEF DESCRIPTION OF THE DRAWINGS

The present invention will hereinafter be described in conjunction with the following drawing figures, wherein like numerals denote like elements, and:

FIG. 1 is a schematic conceptual view of a transmission system; and

FIG. 2 is a schematic sectional view of a peak torque limiter for the transmission system of FIG. 1.

### DETAILED DESCRIPTION

The following detailed description is merely exemplary in nature and is not intended to limit application and uses. Furthermore, there is no intention to be bound by any theory presented in the preceding background or summary of or the following detailed description.

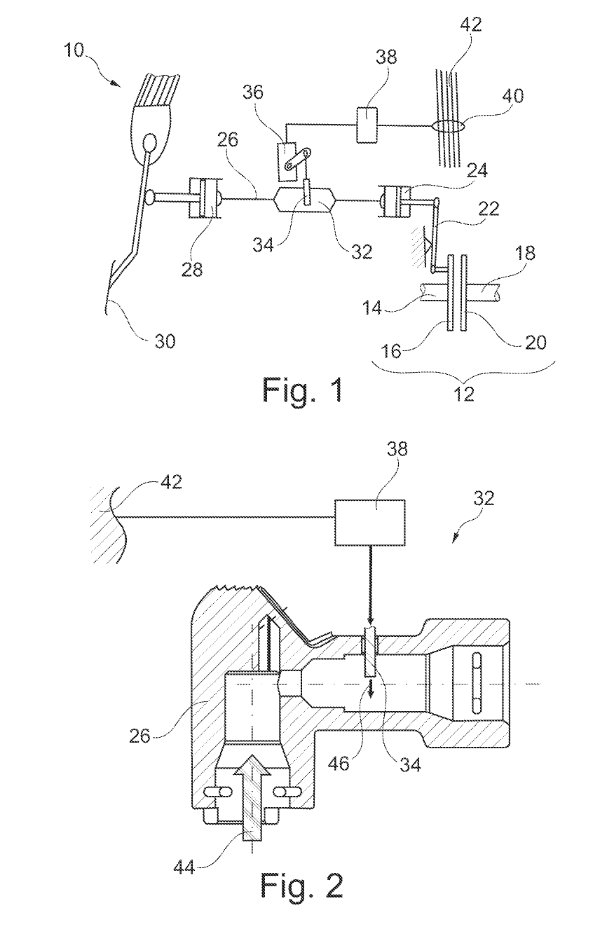

The transmission system 10 as illustrated in FIG. 1 comprises a clutch 12. The clutch 12 comprises an input shaft 14, which terminates in the illustrated embodiment in a clutch disc 16. The clutch 12 further comprises an output shaft 18, which terminates in a clutch pressure plate 20 corresponding to the clutch disc 16 of the input shaft 14. In the illustrated embodiment the input shaft 14 is connected via the clutch disc 16 to a release lever 22 actuated by a slave cylinder 24. The slave cylinder 24 can be actuated via a duct 26 by a master cylinder 28 that is actuated by a pivotable clutch pedal 30.

The duct 26 comprises a peak torque limiter 32, by which a maximum hydraulic diameter of the duct 26 is adjusted. The peak torque limiter 32 comprises a slider 34 for closing and/or opening an orifice inside the duct 26. The slider 34 is moved by a servo actuator motor 36, which is operated by a control unit 38. The control unit 38 is connected via a CAN-bus interface 40 to a CAN-bus 42 of an automotive vehicle. By using the information provided by the CAN-bus 42 the exact situation of the transmission system 10 during the shifting of the gears can be estimated. Based on the information provided by the CAN-bus 42 it is possible to allow at mainly every situation a maximum fast coupling without significant impairments with respect to the provided comfort.

As illustrated in FIG. 2 the slider/cover 34 is positioned in a mainly straight part of the duct 26. When releasing the clutch pedal 30 the input shaft 14 is pressed towards the output shaft 18 by a flow of the hydraulic working fluid in a flow direction 44. The slider 34 is moved in a mainly radial moving direction 46, which is mainly perpendicular of the axial flow direction 44 of the working fluid in this area.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for actuating a hydraulic operated clutch of an automotive gear box for shifting gears, comprising the steps of:
collecting data from a CAN-bus system that comprises torque data and speed data of the automotive gear box; and
adjusting an engagement time for engaging an input shaft with an output shaft based on the data by adjusting a maximum hydraulic diameter for a working fluid for operating the hydraulic operated clutch.

2. The method according to claim 1, further comprising the step of detecting an intended actuation of the hydraulic operated clutch for engaging the input shaft with the output shaft.

3. The method according to claim 1, wherein an actual maximum allowed engagement speed for a relative movement of the input shaft towards the output shaft is calculated and the maximum hydraulic diameter is adjusted for limiting an actual hydraulic pressure based on the actual maximum allowed engagement speed.

4. The method according to claim 1, wherein an actual actuating speed of releasing the hydraulic operated clutch is detected and used for adjusting the maximum hydraulic diameter.

5. The method according to claim 1, wherein a speed difference between the input shaft and the output shaft is used for adjusting the maximum hydraulic diameter.

6. The method according to claim 1, wherein a speed difference of a shifted gear is used for adjusting the maximum hydraulic diameter.

7. The method according to claim 1, wherein a higher maximum hydraulic diameter is set before an engagement of the input shaft to the output shaft.

8. The method according to claim 1, wherein a lower maximum hydraulic diameter is set after an engagement of the input shaft to the output shaft.

9. A controller for actuating a hydraulic operated clutch of an automotive gear box for shifting gears, comprising:
a CAN-bus interface for collecting data from a CAN-bus system, which comprises data about a torque and a speed of the automotive gear box;
an adjustment device for adjusting a maximum hydraulic diameter of an orifice of a hydraulic duct for a working fluid for operating the hydraulic operated clutch; and
an operating unit for operating the adjustment device in dependency of the data for adjusting an engagement time for engaging an input shaft with an output shaft.

10. The controller according to claim 9, wherein the operating unit is connected to a clutch pedal detector for detecting an actual actuating speed of releasing the hydraulic operated clutch.

11. A peak torque limiter for limiting a transferred torque, comprising:
a hydraulic duct for a working fluid for operating a clutch of an automotive gear box for shifting gears; and
a controller for adjusting a maximum hydraulic diameter of the hydraulic duct, the controller comprising:
a CAN-bus interface for collecting data from a CAN-bus system, which comprises data about a torque and a speed of the automotive gear box;
an adjustment device for adjusting the maximum hydraulic diameter of an orifice of the hydraulic duct for the working fluid for operating the clutch and
an operating unit for operating the adjustment device in dependency of the data for adjusting an engagement time for engaging an input shaft with an output shaft.

12. The peak torque limiter according to claim 11, wherein the maximum hydraulic diameter is adjusted by means of a slider, which particularly is movable mainly perpendicular to a flow direction of the working fluid inside the hydraulic duct.

13. A transmission system for an automotive gear box for shifting gears, comprising:
a peak torque limiter, the peak torque limiter comprising:
a hydraulic duct for the working fluid for operating a clutch of the automotive gear box for shifting gears; and
a controller for adjusting a maximum hydraulic diameter of the hydraulic duct, the controller comprising:
a CAN-bus interface for collecting data from a CAN-bus system, which comprises data about a torque and a speed of the automotive gear box;
an adjustment device for adjusting the maximum hydraulic diameter of an orifice of the hydraulic duct for a working fluid for operating the clutch and an operating unit for operating the adjustment device in dependency of the data for adjusting an engagement time for engaging an input shaft with an output shaft,
wherein the hydraulic duct is connected via a hydraulic master cylinder to a clutch pedal and via a hydraulic slave cylinder to the clutch of the automotive gear box.
